(19) United States
(12) Patent Application Publication
(10) Pub. No.: US 2008/0121686 A1
(43) Pub. Date: May 29, 2008

(54) INPUT SYSTEM AND METHOD

(75) Inventors: Ether Sheu, Taipei (TW); Chong-Bing Yang, Taipei (TW); Will Wang, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/557,840

(22) Filed: Nov. 8, 2006

(51) Int. Cl. G06K 7/10

(52) U.S. Cl. 235/375

(57) ABSTRACT

The present invention provides an input system and method applicable to an electronic device. The input method includes editing instruction data required to control execution of an operation by the electronic device and code message data corresponding to the instruction data, storing the edited data in a database, searching the database for the instruction data corresponding to the code message data by reading the code message data and referring to the code message data read, and controlling execution of the related operation by the electronic device. The present invention allows various instruction-related operations to be executed by an electronic device not installed with input equipment such as a mouse and a keyboard, prevents system failure which may otherwise arise from a human-caused mistake in operation, enhances operating safety and efficiency of the electronic device, and effectively reduces the cost of hardware configuration of the electronic device.

### BACKGROUND OF THE INVENTION

1. Field of the Invention

The present invention relates to a technique of inputting control instructions, and more particularly, to an input system and method of inputting control instructions without using a keyboard or a mouse.

2. Description of the Prior Art

In general, all kinds of electronic devices are equipped with input equipment for inputting instruction data by users. A computer, for example, is typically equipped with input equipment such as a mouse and a keyboard for users to input various instruction data with a view to controlling execution of related operations by the computer.

Nevertheless, among various automated operating systems, a cellular phone testing production line, for example, entails a software engineer's designing a required testing program and incorporating the required testing program into a computer system installed in the production line, and entails a production line testing worker's inputting several simple operation-related instructions, using input equipment such as a mouse and a keyboard, for example, clicking on a button pertaining to a “starting a testing program” function by means of a mouse, or entering the serial number of a cellular phone to be tested. However, with the mouse or keyboard, the production line testing worker not only controls the testing program but may also control the execution of any other applications installed in the computer. As a result, in addition to their testing jobs, production line testing workers on duty often use the computer and the input equipment thereof to conduct affairs irrelevant to their duties, such as games and online chats, thus interfering with a testing operation underway, distracting the production line testing workers themselves from their work, and compromising their performance. For instance, to perform a life testing operation on the keys of a cellular phone, a design worker sets the pressing strength of a pressing device (for example, 50 g), to allow the pressing device to be pressed for a plurality of times (1000 times) and therefore a corresponding pressing force to be exerted on the keys of the cellular phone being tested. If during a testing operation a testing worker inadvertently changes the pressing strength to 500g with a mouse or a keyboard, not only will the findings of the life testing operation performed on the keys of a cellular phone be inaccurate, but the keys of the cellular phone will be readily damaged during the testing operation because of the excessive pressing force. Furthermore, an undue operation performed by a worker at a production line, using the aforesaid input equipment, can end up in a mild scenario where a testing attribute of a testing operation program is altered and thus the testing operation fails to comply with related specifications and requirements, or a serious scenario where some required system-related documents are deleted and removed from the computer and thus the computer malfunctions in such a way to prevent the testing operation from being carried out.

Accordingly, an issue calling for urgent solution involves overcoming the drawbacks of the prior art arising from the installation of input equipment, such as a mouse or a keyboard, in a computer at a production line.

### SUMMARY OF THE INVENTION

In light of the aforesaid drawbacks of the prior art, it is a primary objective of the present invention to provide an input system and method of inputting various instruction data into an electronic device not equipped with any input equipment such as a mouse and a keyboard and executing the operation of the electronic device to prevent the testing findings from being affected and prevent the electronic device from being damaged because of a wrong operation-related instruction inputted by means of the input equipment.

Another objective of the present invention is to provide an input system and method, so as to enhance operating safety and efficiency of an electronic device.

A further objective of the present invention is to provide an input system and method, so as to effectively reduce the cost of installation of hardware in an electronic device.

In order to achieve the above and other objectives, the present invention provides an input system and method applicable to an electronic device. The input system of the present invention comprises a database for storing a plurality of instruction data required to control execution of an operation by the electronic device and code message data corresponding to the instruction data, an inputting module for reading the code message data, a searching module for searching the database for the instruction data corresponding to the code message data by referring to the code message data read by the inputting module, and a processing module controlling execution of the related operation by the electronic device by referring to the instruction data searched out by the searching module.

Between the instruction data and the code message data stored in the database is a one-to-one relationship. In a preferred embodiment, the code message data stored in the database are exemplified by barcode data; correspondingly, the inputting module is exemplified by a barcode reader.

In addition to the input system, the present invention discloses an input method applicable to an electronic device. The input method comprises the steps of editing instruction data required to control execution of an operation by the electronic device and code message data corresponding to the instruction data, storing the edited data in a database, reading the code message data, searching the database for the instruction data corresponding to the code message data by referring to the code message data read, and controlling execution of the related operation by the electronic device.

Accordingly, with an input system and method of the present invention, a user can input instruction data for controlling execution of a related operation by an electronic device, without using a conventional input interface such as a mouse and a keyboard. The present invention effectively prevents an operation from being wrongly carried out because of an instruction inputted by means of a mouse or a keyboard. Also, the present invention prevents a user from using a mouse or a keyboard to perform other jobs irrelevant to the user's duties. Lastly, the present invention allows instruction data to be directly read by a barcode reader, thus enabling the user to input data conveniently, enhancing operating safety and efficiency of an electronic device, and effectively reducing the cost of installation of hardware in the electronic device.

### BRIEF DESCRIPTION OF THE DRAWINGS

FIG. 1 is a block diagram showing an input system of the present invention; and

FIG. 2 is a flow chart showing an operating process of the input system shown in FIG. 1.

### DETAILED DESCRIPTION OF THE PREFERRED EMBODIMENT

The following specific embodiment is provided to illustrate the present invention. Others ordinarily skilled in the art can readily gain an insight into other advantages and features of the present invention based on the contents disclosed in this specification.

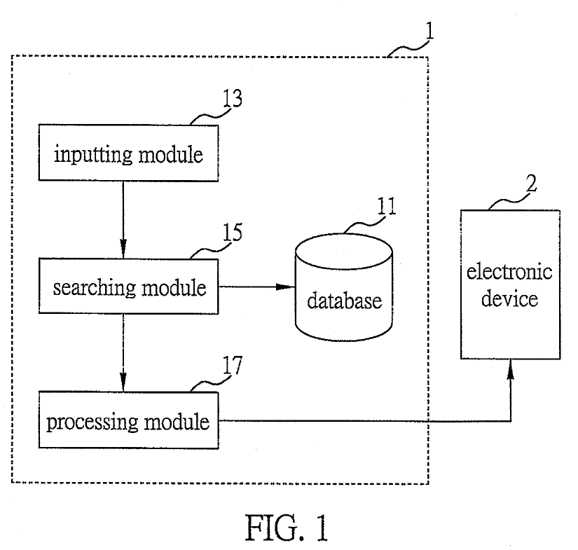

Referring to FIG. 1, which is a block diagram showing an input system 1 of the present invention, a point to note is that the input system 1 may comprise other elements. To make the drawings and the specification simpler, the basic structure herein merely shows the elements pertaining to the present invention.

In this embodiment, the input system 1 works with an electronic device 2. The electronic device 2 functions as a testing machine for testing a specific program. Examples of the specific program are, namely a BIOS program, a cellular phone operation program, and an operating system program. Any specific program that has passed the testing operation is installed in electronic products. The electronic device 2 refers to a testing machine at a production line wherein a production line worker tests the specific program by inputting various instruction data to the electronic device 2 installed with the input system 1, without using an input equipment like a mouse or a keyboard. The input system 1 of the present invention solves a drawback of the prior art, that is, inputting a wrong operation-related instruction with the aforesaid input equipment affects the testing result and even damages the electronic device. As shown in FIG. 1, the input system 1 comprises a database 11, an inputting module 13, a searching module 15, and a processing module 17. The above-mentioned of the input system 1 of the present invention are described in detail below.

The database 11 stores a plurality of instruction data required to control execution of an operation by the electronic device 2 and code message data corresponding to the instruction data. In this embodiment, a one-to-one relationship exists between the instruction data and the code message data stored in the database 11. Examples of the instruction data corresponding to the code message data include, but are not limited to, Init (an instruction of initialization), Test (an instruction to execute the testing), Restart (an instruction to restart the system), Shutdown (an instruction to shutdown the system), an instruction to execute the testing anew, and another instruction to stop the testing.

The inputting module 13 is configured to read the code message data and input control-related instructions corresponding to the code message data to the electronic device 2. In this embodiment, the inputting module 13 is a barcode reader having communication connection with the electronic device 2, whereas the code message data are barcode data. A point to note is that, in this regard, the present invention may also adopt any other identification method like radio frequency identification (RFID), without being subject to any specific limitation. Accordingly, a testing worker can quickly and accurately input instruction data, and thus the present invention overcomes a drawback of the prior art, that is, inputting instruction data entails the use of input equipment like a mouse or a keyboard, not to mention that the present invention makes an operation simpler and more efficient.

The searching module 15 searches the database 11 for the instruction data corresponding to the code message data, by referring to the code message data read by the inputting module 13.

The processing module 17 controls execution of an operation on the related instruction data by the electronic device 2, by referring to the instruction data searched out by the searching module 15.

Afterward, a related testing operation is carried out to a cellular phone by means of a testing operation program installed in the electronic device 2.

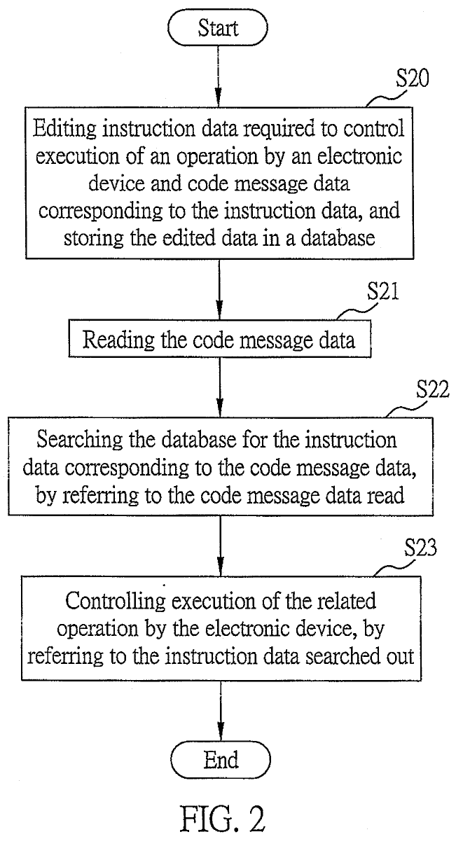

FIG. 2 is a flow chart showing an operating process of an input method of the present invention. In an embodiment described below, the input method of the present invention is applicable to the electronic device 2 installed at a production line, such as a cellular phone testing production line. With the input method of the present invention, a user inputs instruction data required for execution of a testing operation and executes the testing operation by means of a testing operation program installed in the electronic device 2.

The input method of this embodiment is described in conjunction with the input method 1 shown in FIG. 1. First, in Step S20, editing instruction data required to control execution of an operation by the electronic device 2 and code message data corresponding to the instruction data, and storing the edited data in a database 11. In this embodiment, between the instruction data and the code message data stored in the database 11 is a one-to-one relationship. Then, proceed to step S21.

In step S21, the inputting module 13 reads the code message data. In this embodiment, the inputting module 13 is a barcode reader having communication connection with the electronic device 2, whereas the code message data are barcode data. Then, proceed to step S22.

In step S22, the searching module 15 searches the database 11 for the instruction data corresponding to the code message data, by referring to the code message data read by the inputting module 13. Then, proceed to step S23.

In step S23, the processing module 17 controls execution of the related operation on the related instruction data by the electronic device 2, by referring to the instruction data searched out by the searching module 15.

In short, an input system and method of the present invention involve setting barcode data corresponding to control-related instructions respectively so as to allow a production line worker to control execution of a related operation by a computer by reading the barcode data corresponding to the control-related instructions to be executed, using a barcode reader connected to a computer. The present invention discloses inputting data without using any known input equipment like a mouse or a keyboard, and thus the present invention effectively prevents malfunctioning of a system that might otherwise occur because of improper operation of a mouse or a keyboard by a user. In addition, an input system and method of the present invention spare the use of a mouse or a keyboard, thus effectively reducing the cost of installation of hardware in an electronic device, but making an input operation more convenient and efficient.

The aforesaid embodiments merely serve as the preferred embodiments of the present invention. They should not be construed as to limit the scope of the present invention. Hence, any other changes can be made in the present invention. It will be apparent to those ordinarily skilled in the art that all equivalent modifications or changes made, without departing from the spirit and the technical concepts disclosed by the present invention, should fall within the scope of the appended claims.

What is claimed is:

1. An input system applicable to an electronic device, the input system comprising:
a database for storing a plurality of instruction data required to control execution of an operation by the electronic device and code message data corresponding to the instruction data;
an inputting module for reading the code message data;
a searching module for searching the database for the instruction data corresponding to the code message data, by referring to the code message data read by the inputting module; and
a processing module for controlling execution of a related operation by the electronic device, by referring to the instruction data searched out by the searching module.

2. The input system of claim 1, wherein between the instruction data and the code message data stored in the database is a one-to-one relationship.

3. The input system of claim 1, wherein the inputting module is a barcode reader.

4. The input system of claim 3, wherein the code message data stored in the database are barcode data.

5. An input method applicable to an electronic device, the input method comprising the steps of:
editing instruction data required to control execution of an operation by the electronic device and code message data corresponding to the instruction data;
reading the code message data;
searching the edited message data for the instruction data corresponding to the code message data, by referring to the code message data read; and
controlling execution of a related operation by the electronic device, by referring to the instruction data searched out.

6. The input method of claim 5, wherein between the instruction data and the code message data is a one-to-one relationship.

7. The input method of claim 5, wherein an inputting module performs the step of reading the code message data.

8. The input method of claim 7, wherein the inputting module is a barcode reader.

9. The input method of claim 8, wherein the code message data are barcode data.
